(19) United States
(12) Patent Application Publication
(10) Pub. No.: US 2016/0016304 A1
(43) Pub. Date: Jan. 21, 2016

(54) FOLDABLE WORKBENCH

(71) Applicant: Shou Qiang ZHU, Ontario, CA (US)

(72) Inventor: Shou Qiang ZHU, Ontario, CA (US)

(73) Assignee: IP POWER HOLDINGS LIMITED, Hong Kong (CN)

(21) Appl. No.: 14/800,558

(22) Filed: Jul. 15, 2015

Related U.S. Application Data
(60) Provisional application No. 62/024,910, filed on Jul. 15, 2014.

(51) Int. Cl. B25H 1/04; B25H 1/12

(52) U.S. Cl. CPC B25H 1/04; B25H 1/12

(57) ABSTRACT

A foldable workbench may include a support structure, a work surface, a connecting frame and a backboard. The support structure includes two front legs, two rear legs, a front cross supporting unit, a rear cross supporting unit and a foot pedal. Each front leg is pivotally connected to a rear leg at a center portion thereof to form an “X” structure on both sides underneath the work surface. In one embodiment, the support structure may further include an upper cross supporting unit, a foot pedal and two upper supporting units. The foot pedal is pivotally connected to the support structure, so when the user steps on the foot pedal to trigger the movement of the front legs and rear legs, the support structure will collapse, and meanwhile the work surface will move toward the collapsed support structure, so the workbench is folded and size of thereof is significantly reduced.

### CROSS-REFERENCE TO RELATED APPLICATIONS

This application claims priority under 35 U.S.C. §119 (e) to U.S. Provisional Patent Application Ser. No. 62/024,910 filed on Jul. 15, 2014, the entire contents of which are hereby incorporated by reference.

### FIELD OF THE INVENTION

The present invention relates to a workbench, and more particularly to a workbench that can be folded to significantly reduce the size thereof.

### BACKGROUND OF THE INVENTION

Conventional workbenches are not foldable and usually occupy a lot of spaces whether they are in use or not. However, many owners have limited space in their workshops and thus it is desirable that the workbench can be folded and stored in a smaller space when not in use. It is also desirable that the workbench is easy to be folded and unfolded. A number of patents are directed to various workbenches that has typically has a work surface and a collapsible support structure.

U.S. Pat. No. 6,286,824 to Sagol discloses a worktable supported on a workhorse that is either collapsible or non-collapsible as shown in FIG. 1. The work surface consists of a member that can be attached to the top of the workhorse, and side work-plates that are collapsible. They are supported in the open position by support legs. The work surface includes various elements that are useful for receiving various tools and hardware. The mechanism for collapsing Sagol's worktable is different from the present invention.

U.S. Pat. No. 7,089,980 to Rulli discloses a multi-tool rotatable workbench that includes a support structure and a work surface drum having work surfaces, the drum being rotatably disposed on the support structure, as shown in FIG. 2. Each of the work surfaces includes tool attachment means for rapidly attaching and removing tools, work platforms, workpiece holding devices, and the like. Drum indexing and stop means are provided for selectively positioning and securing the work surface drum in such a configuration that at least one work surface is substantially level relative to the ground, while all other work surfaces are in a storage position. However, Rulli's workbench does not seem to be easily assembled or disassembled, and thus not easy for transport and storage.

Therefore, there remains a need for a new and improved workbench that can be easily assemble or disassembled, and the size of the disassembled workbench can be significantly reduced for easy transport and storage.

### SUMMARY OF THE INVENTION

It is an object of the present invention to provide a foldable workbench that can be folded to significantly reduce to a compact size and stored in a smaller space when not in use.

It is another object of the present invention to provide a foldable workbench that can be easily assembled and disassembled to minimize its profile for transport and storage.

It is a further object of the present invention to provide a foldable workbench that can be easily set up and erected on a support structure.

In one aspect, a foldable workbench may comprise a support structure, a work surface, a connecting frame and a backboard. The support structure may comprise two front legs, two rear legs, a front cross supporting unit and a rear cross supporting unit. Each front leg is pivotally connected to a rear leg at a center portion thereof to form an “X” structure on both sides underneath the work surface. The front cross supporting unit is used to connect two front legs, while the rear cross supporting unit is used to connect two rear legs to increase the structural strength of the support structure.

In one embodiment, the support structure may further include an upper cross supporting unit, a foot pedal and two upper supporting units. The upper cross supporting unit is disposed at an upper portion of the rear legs to connect the upper portion of the rear legs to increase the strength of the upper portion of the support structure. One end of each upper supporting unit is pivotally connected to the upper portion of each of the rear leg, while the other end of each upper supporting unit is pivotally connected to the work surface, more specifically underneath the work surface near a front portion thereof. The foot pedal may include a first pedal portion and a second pedal portion, wherein one end of the first pedal portion is pivotally connected with a lower portion of one of the front legs and the other end is pivotally connected to one end of the second pedal portion, while the other end of the second pedal portion is pivotally connected to a lower portion of one of the rear legs.

The work surface has the front side and a rear portion. An upper portion of each first leg is pivotally connected to the work surface, more specifically underneath the work surface near the rear portion thereof.

The connecting frame is disposed on the rear portion of the work surface, which may comprise two vertical members and a horizontal member. Each vertical member has an opening to receive a connecting unit of the backboard, and the horizontal member may include a plurality of holes along the horizontal axis. The backboard may comprise a peg board, two connecting units and a storage shelf. The two connecting units are disposed at a bottom portion of the peg board, and are plugged into the opening of the connecting frame to form the workbench. In one embodiment, a plurality of holes are formed on a top portion of the storage shelf to receive screws to secure the backboard to a flat surface.

When the user finishes using the workbench, he/she can first remove connecting units of the backboard from the openings of the connecting frame, and the connecting frame can be pushed down. In one embodiment, if the backboard is secured on the wall, the screws may have to be unscrewed first. The user can then step on the foot pedal to collapse the support structure and further the work surface. More specifically, since the foot pedal are pivotally connected with the lower portions of the one of the front legs and rear legs through the first pedal portion and second pedal portion respectively, the downward movement of the foot pedal would trigger the front legs and rear legs to move toward each other, namely collapsing the support structure. Since the rear legs are pivotally connected to the work surface, and the front legs are indirectly pivotally connected to the work surface through the upper supporting units, when the user steps on the foot pedal to trigger the movement of the front legs and rear legs, the support structure will collapse, and meanwhile the work surface will move toward the collapsed support structure, so the workbench is folded and size of thereof is significantly reduced.

### BRIEF DESCRIPTION OF THE DRAWINGS

FIG. 1 is a prior art illustrating discloses a worktable supported on a workhorse.

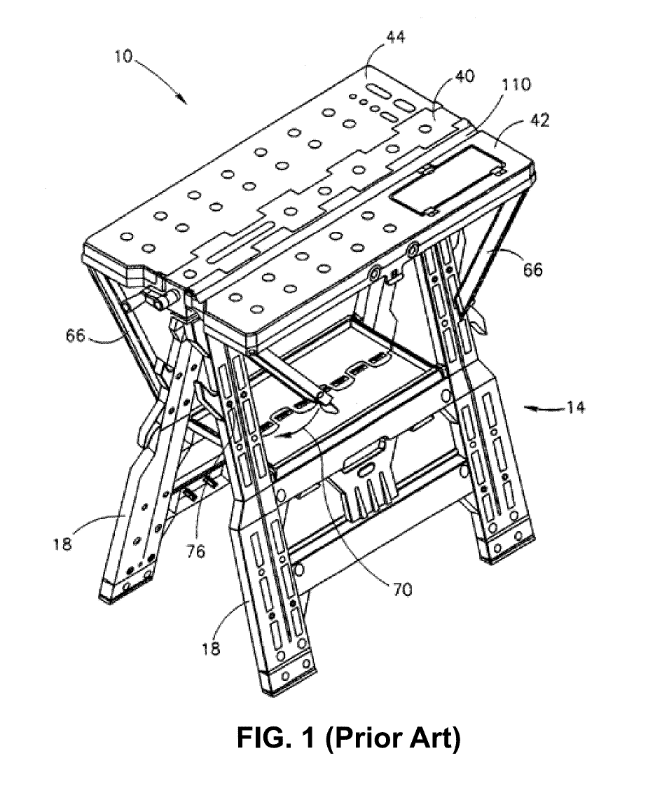

FIG. 2 is a prior art illustrating a multi-tool rotatable workbench that includes a support structure and a work surface drum having work surfaces, the drum being rotatably disposed on the support structure.

FIG. 3 illustrates a folded workbench in the present invention.

FIG. 4 illustrates an exemplary embodiment of the workbench including the backboard in the present invention.

FIG. 5 illustrates another embodiment of the workbench including the backboard in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

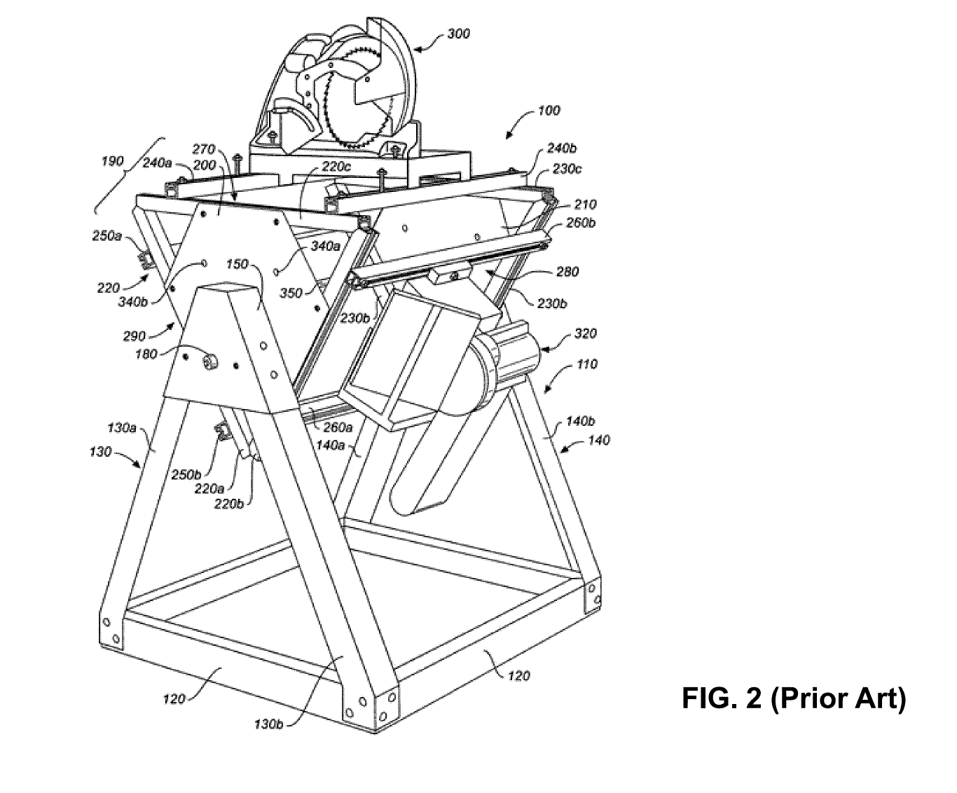

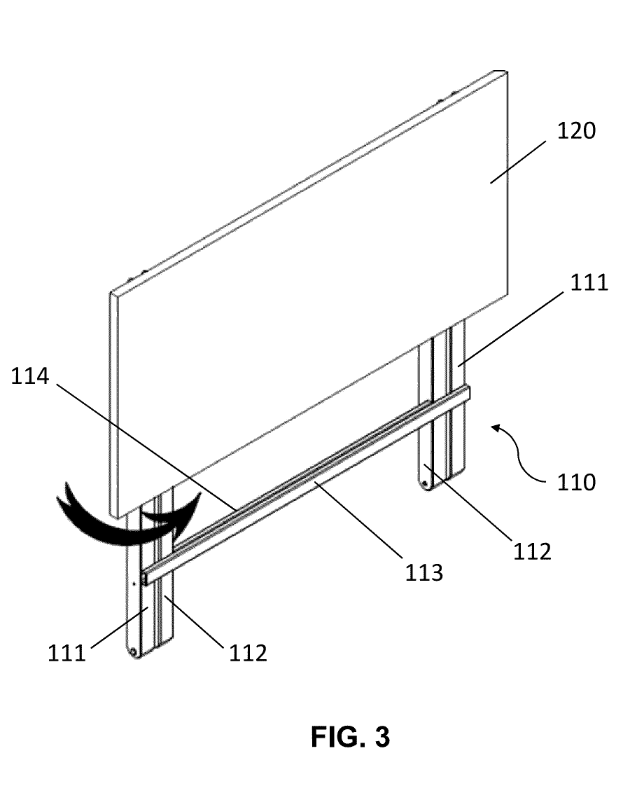

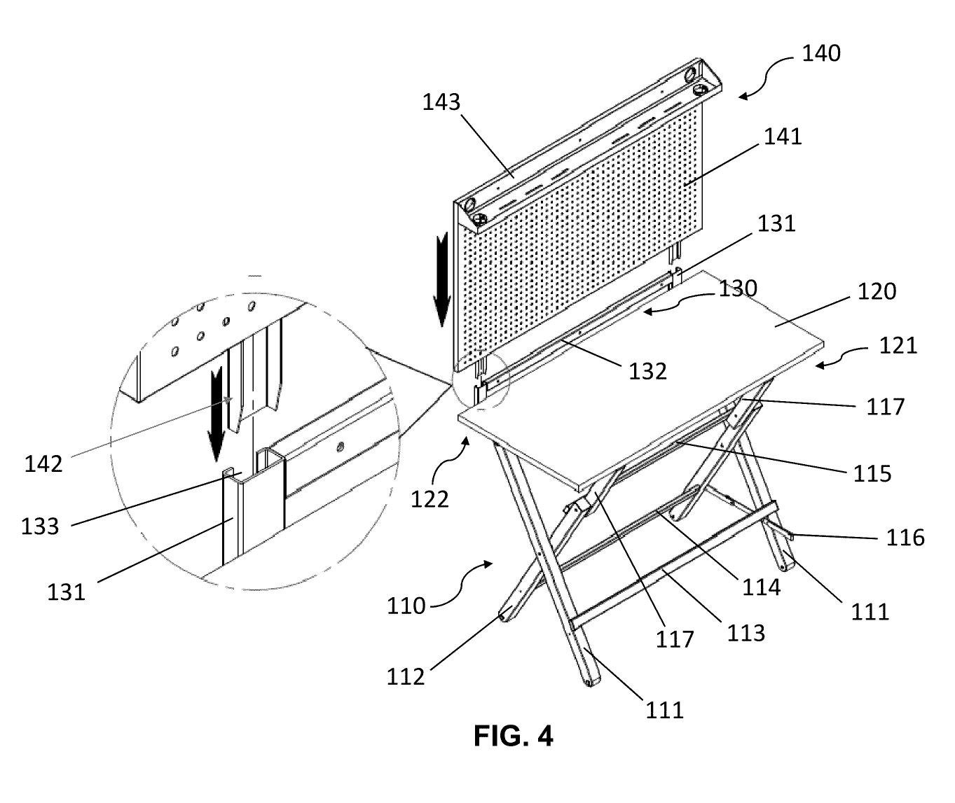

Referring to FIGS. 2 to 5, a foldable workbench may comprise a support structure 110, a work surface 120, a connecting frame 130 and a backboard 140. The support structure 110 may comprise two front legs 111, two rear legs 112, a front cross supporting unit 113 and a rear cross supporting unit 114. Each front leg 111 is pivotally connected to a rear leg 112 at a center portion thereof to form an “X” structure on both sides underneath the work surface 120. The front cross supporting unit 113 is used to connect two front legs 111, while the rear cross supporting unit 114 is used to connect two rear legs 112 to increase the structural strength of the support structure 110.

The support structure 10 may further include an upper cross supporting unit 115, a foot pedal 116 and a pair of upper supporting units 117. The upper cross supporting unit 115 is disposed at an upper portion of the rear legs 112 to connect the upper portion of the rear legs 112 to increase the strength of the upper portion of the support structure 110. One end of each upper supporting unit 117 is pivotally connected to the upper portion of each of the rear leg 112, while the other end of each upper supporting unit 117 is pivotally connected to the work surface 120, more specifically underneath the work surface 121 near a front portion (121) thereof. The foot pedal 116 may include a first pedal portion 161 and a second pedal portion 162, wherein one end of the first pedal portion 161 is pivotally connected with a lower portion of one of the front legs 111 and the other end is pivotally connected to one end of the second pedal portion 162, while the other end of the second pedal portion 162 is pivotally connected to a lower portion of one of the rear legs 112.

The work surface 120 has the front portion 121 and a rear portion 122. An upper portion of each first leg 111 is indirectly and pivotally connected to the work surface 120 through the upper supporting units 117, more specifically underneath the work surface 120 near the rear portion 122 thereof.

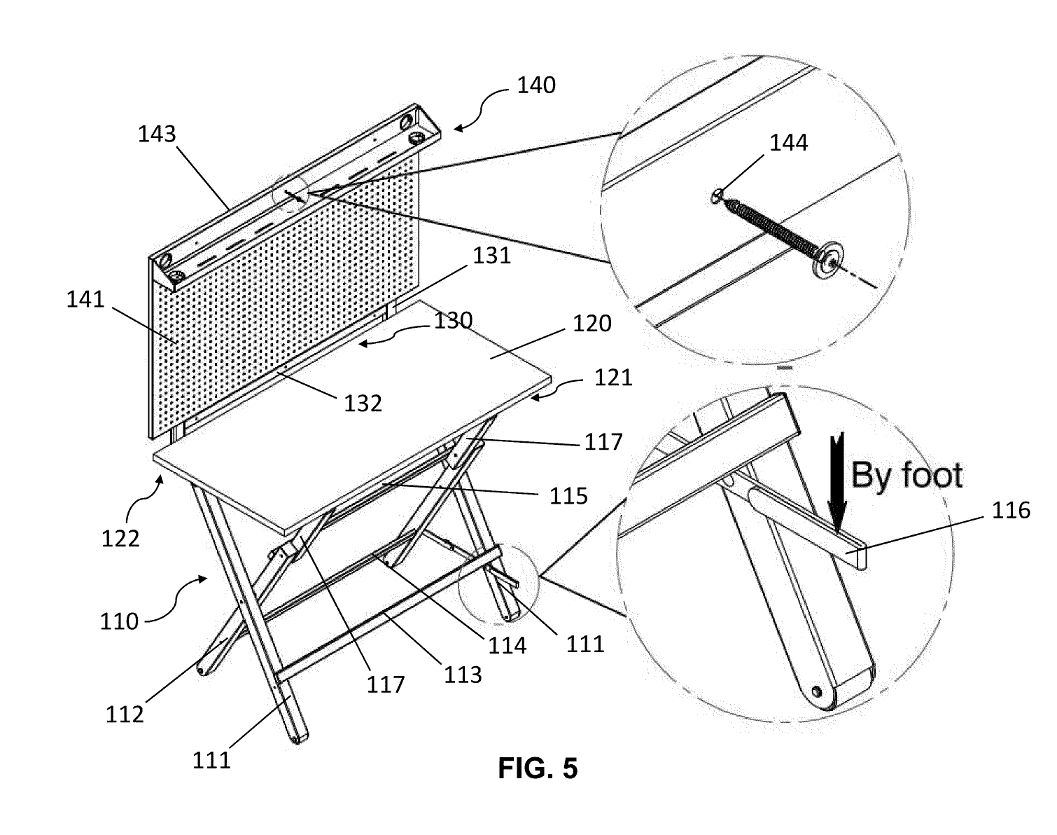

The connecting frame 130 is disposed on the rear portion 122 of the work surface 120, which may comprise two vertical members 131 and a horizontal member 132. Each vertical member 131 has an opening 133 to receive a connecting unit 142 of the backboard 140, and the horizontal member 132 may include a plurality of holes along the horizontal axis. The backboard 140 may comprise a peg board 141, two connecting units 142 and a storage shelf 143. The two connecting units 142 are disposed at a bottom portion of the peg board 141, and are plugged into the opening 133 of the connecting frame 130 to form the workbench. In one embodiment as shown in FIG. 5, a plurality of holes 144 are formed on a top portion of the storage shelf 143 to receive screws to secure the backboard to a flat surface.

As shown in FIG. 5, when the user finishes using the workbench, he/she can first remove connecting units 142 of the backboard 140 from the openings of the connecting frame 130, and the connecting frame 130 can be pushed down. In one embodiment, if the backboard 140 is secured on the wall, the screws may have to be unscrewed first. The user can then step on the foot pedal 116 to collapse the support structure 110 and further the work surface 120. More specifically, since the foot pedal are pivotally connected with the lower portions of the one of the front legs 111 and rear legs 112 through the first pedal portion 161 and second pedal portion 162 respectively, the downward movement of the foot pedal 116 would trigger the front legs 111 and rear legs 112 to move toward each other, namely collapsing the support structure 110. Since the rear legs 112 are pivotally connected to the work surface 120, and the front legs 111 are indirectly pivotally connected to the work surface 120 through the upper supporting units 117, when the user steps on the foot pedal 116 to trigger the movement of the front legs 111 and rear legs 112, the support structure 110 will collapse, and meanwhile the work surface 120 will move toward the collapsed support structure 110, so the workbench is folded and size of thereof is significantly reduced as shown in FIG. 2.

When the user wants to use the workbench again, he/she can reverse the workbench folding process by first lifting the work surface 120 until the support structure 110 is erected and the work surface is substantially parallel to the ground. The connecting frame 130 can then be pulled out to connect the backboard 140 to the support structure 110 and work surface 120.

Having described the invention by the description and illustrations above, it should be understood that these are exemplary of the invention and are not to be considered as limiting. Accordingly, the invention is not to be considered as limited by the foregoing description, but includes any equivalent.

What is claimed is:

1. A foldable workbench comprising a support structure and a work surface, said support structure comprising a pair of front legs, a pair of rear legs, and a foot pedal, said food pedal having a first pedal portion and a second pedal portion, wherein one end of the first pedal portion is pivotally connected with a lower portion of one of the front legs and the other end is pivotally connected to one end of the second pedal portion, while the other end of the second pedal portion is pivotally connected to a lower portion of one of the rear legs,
wherein each front leg is pivotally connected to a rear leg at a center portion thereof to form an “X” structure on both sides underneath the work surface, and when the foot pedal is moved downwardly to trigger the front legs and rear legs, the support structure collapses, and meanwhile the work surface moves toward the collapsed support structure to fold the workbench.

2. The foldable workbench of claim 1, the support structure further comprising a front cross supporting unit and a rear cross supporting unit, wherein the front cross supporting unit is used to connect two front legs, while the rear cross supporting unit is used to connect two rear legs to increase the structural strength of the support structure.

3. The foldable workbench of claim 1, the supporting structure further comprising an upper cross supporting unit, which is disposed at an upper portion of the rear legs to connect the upper portion of the rear legs to increase the strength of the upper portion of the support structure.

4. The foldable workbench of claim 2, the supporting structure further comprising an upper cross supporting unit, which is disposed at an upper portion of the rear legs to connect the upper portion of the rear legs to increase the strength of the upper portion of the support structure.

5. The foldable workbench of claim 1, the supporting structure further comprising a pair of upper supporting units; one end of each upper supporting unit pivotally connected to the upper portion of each of the rear leg, while the other end of each upper supporting unit is pivotally connected to the work surface.

6. The foldable workbench of claim 4, the supporting structure further comprising a pair of upper supporting units; one end of each upper supporting unit pivotally connected to the upper portion of each of the rear leg, while the other end of each upper supporting unit is pivotally connected to the work surface.

7. The foldable workbench of claim 6, wherein the work surface has a front portion and a rear portion, and an upper portion of each first leg is indirectly and pivotally connected to the work surface through the upper supporting units.

8. The foldable workbench of claim 1, further comprising a connecting frame and a backboard, wherein the connecting frame is disposed on a rear portion of the work surface, and the connecting frame includes two vertical members and a horizontal member, and each vertical member has an opening to receive a connecting unit of the backboard.

9. The foldable workbench of claim 7, further comprising a connecting frame and a backboard, wherein the connecting frame is disposed on a rear portion of the work surface, and the connecting frame includes two vertical members and a horizontal member, and each vertical member is configured to connect with the backboard.

10. The foldable workbench of claim 7, wherein the backboard includes a peg board, a pair of connecting units, and a storage shelf, and the connecting units are disposed at a bottom portion of the peg board, and are plugged into the opening of the connecting frame to connect with the backboard.
